(19) United States
(12) Patent Application Publication
(10) Pub. No.: US 2012/0293873 A1
(43) Pub. Date: Nov. 22, 2012

(54) LENS STRUCTURE

(75) Inventor: Cheng-Nan Chiang, Taipei (TW)

(73) Assignee: ABILITY ENTERPRISE CO., LTD., Taipei (TW)

(21) Appl. No.: 13/347,020

(22) Filed: Jan. 10, 2012

(30) Foreign Application Priority Data
May 19, 2011 (TW) 100117626

(51) Int. Cl. G02B 7/10

(52) U.S. Cl. 359/694

(57) ABSTRACT

The invention discloses a lens structure, which includes a first lens barrel, a second lens barrel and a third lens barrel. The first lens barrel has at least one guide groove. The second lens barrel is disposed within the first lens barrel, and has at least one opening having at least one concave groove. The third lens barrel is disposed within the second lens barrel, and includes at least one guide pin and at least one subsidiary structure. The guide pin moves along the guide groove, and the subsidiary structure moves along the concave groove of the opening.

This application claims the benefit of Taiwan application Serial No. 100117626, filed May 19, 2011, the subject matter of which is incorporated herein by reference.

### BACKGROUND OF THE INVENTION

1. Field of the Invention

The invention relates in general to a lens structure, and more particularly to a lens structure used in a video recording device.

2. Description of the Related Art

Along with the advance in technology, digital video recording devices have been widely used in various electronic products such as digital camera, digital video recorder, mobile phone, personal digital assistant (PDA). A digital video recording device includes a lens structure and an image sensor. The lens structure can focuses an image on an image sensor, which further converts optical video signal into electrical signal.

A conventional lens structure normally includes a cam lens barrel and a lens frame. The cam lens barrel and the lens frame respectively have a guide groove and a guide pin. The guide pin moves along the guide groove and controls the relative position between the lens frame and the cam lens barrel to achieve zooming function. However, when a conventional lens structure drops or collides with an object, the guide pin may come off the guide groove, so that relative movement between the lens frame and the cam lens barrel is incapacitated, and the lens structure is thus out of order.

To resolve the above disadvantages of the generally known technology, a lens structure conformed to consumers' needs is thus in need.

### SUMMARY OF THE INVENTION

The invention is directed to a lens structure conformed to consumers' needs.

To resolve the above problems, the invention discloses a lens structure, which includes a first lens barrel, a second lens barrel and a third lens barrel. The first lens barrel has at least one guide groove. The second lens barrel is disposed within the first lens barrel, and has at least one opening having at least one concave groove. The third lens barrel is disposed within the second lens barrel, and includes at least one guide pin and at least one subsidiary structure. The guide pin moves along the guide groove, and the subsidiary structure moves along the concave groove of the opening.

Through the lens structure of the invention, the subsidiary structure of the third lens barrel moves along the concave groove of the second lens barrel for limiting the position of the guide pin, so that the guide pin will not come off the guide groove of the first lens barrel. Thus, when the lens structure of the invention drops or collides with an object, the guide pin of the third lens barrel will not come off the guide groove of the first lens barrel and cause damage to the lens structure.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A shows a decomposition diagram of a lens structure according to an embodiment of the invention;

FIG. 1B shows the third lens barrel of FIG. 1A disposed within the second lens barrel;

FIG. 1C shows a schematic diagram of the third lens barrel;

FIG. 1D is a cross-sectional top view showing the subsidiary structure of the third lens barrel moving along the concave groove of the second lens barrel;

FIG. 1E shows a front view of the subsidiary structure;

FIG. 1F is a cross-sectional view showing the subsidiary structure moving along the concave groove;

FIG. 1G is a cross-sectional view showing the subsidiary structure moving along another concave groove;

FIG. 1H shows a front view of another subsidiary structure;

FIG. 1I is a cross-sectional view showing the subsidiary structure moving along the concave groove;

FIG. 2A shows a front view of a subsidiary structure according to another embodiment of the invention;

FIGS. 2B˜2E are cross-sectional views showing the subsidiary structure moving along the concave groove;

FIG. 3A shows a front view of a subsidiary structure according to yet another embodiment of the invention; and

FIGS. 3B˜3C are cross-sectional views showing the subsidiary structure moving along the concave groove.

### DETAILED DESCRIPTION OF THE INVENTION

A number of embodiments of the invention are disclosed below. Apart from the descriptions disclosed below, the invention can further be used in other embodiments, and the scope of protection of the invention is not limited by the embodiments but is defined in the claims. To provide detailed descriptions and make the invention easier to understand, the elements are not illustrated in the drawings according to actual scaling. The dimensions of some elements are exaggerated in the drawing. To keep the drawing simple, some irrelevant parts are not illustrated or are even omitted.

The invention is related to a lens structure, which can be widely used in various products with an optical imaging lens such as digital camera, digital video recorder, mobile phone, personal digital assistant (PDA), global positioning system (GPS) and driving recorder.

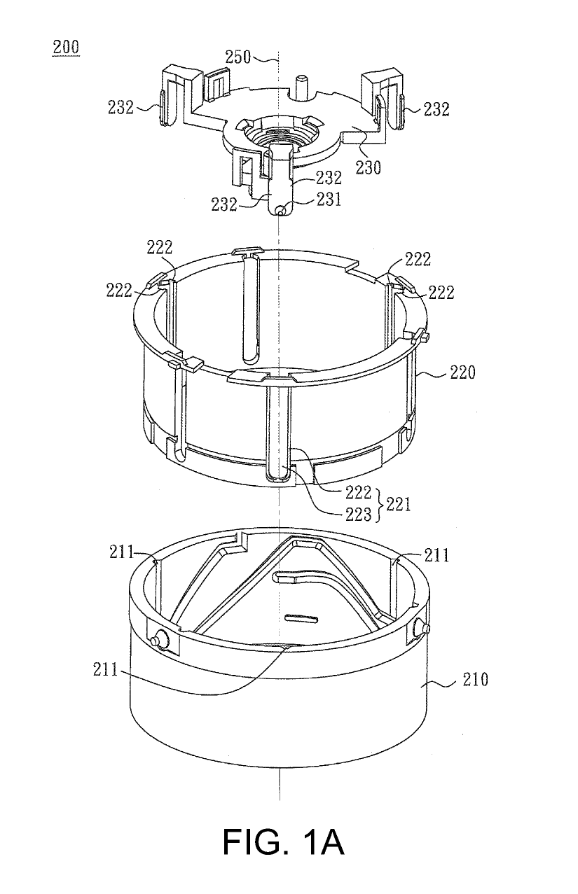

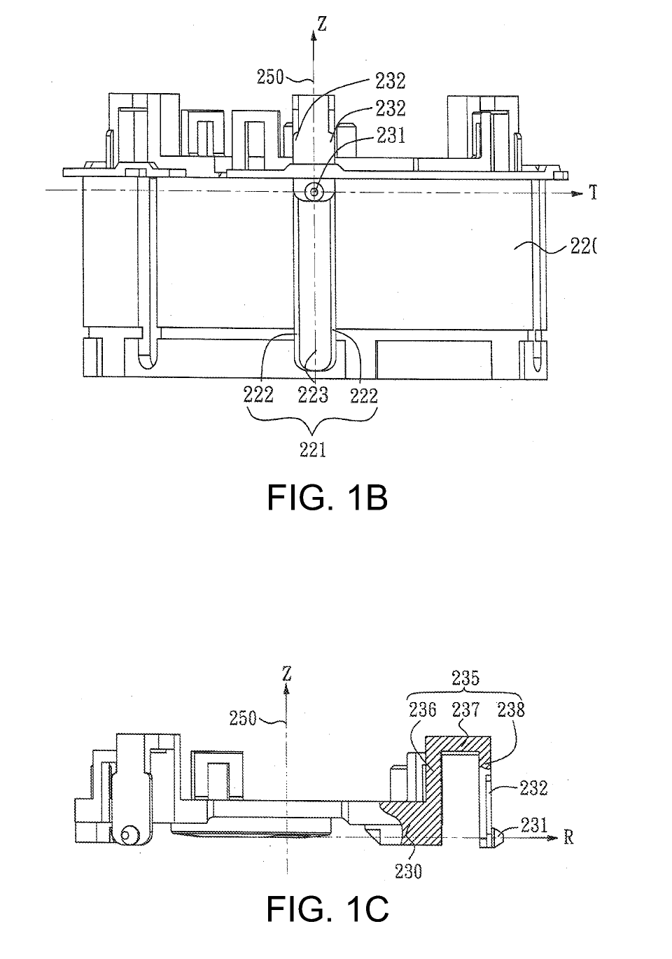

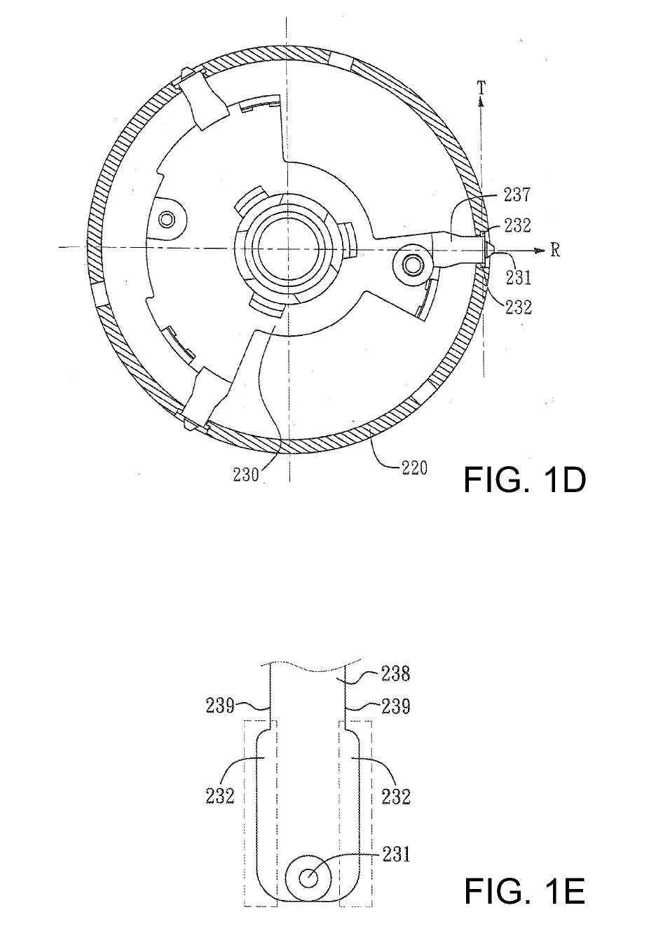

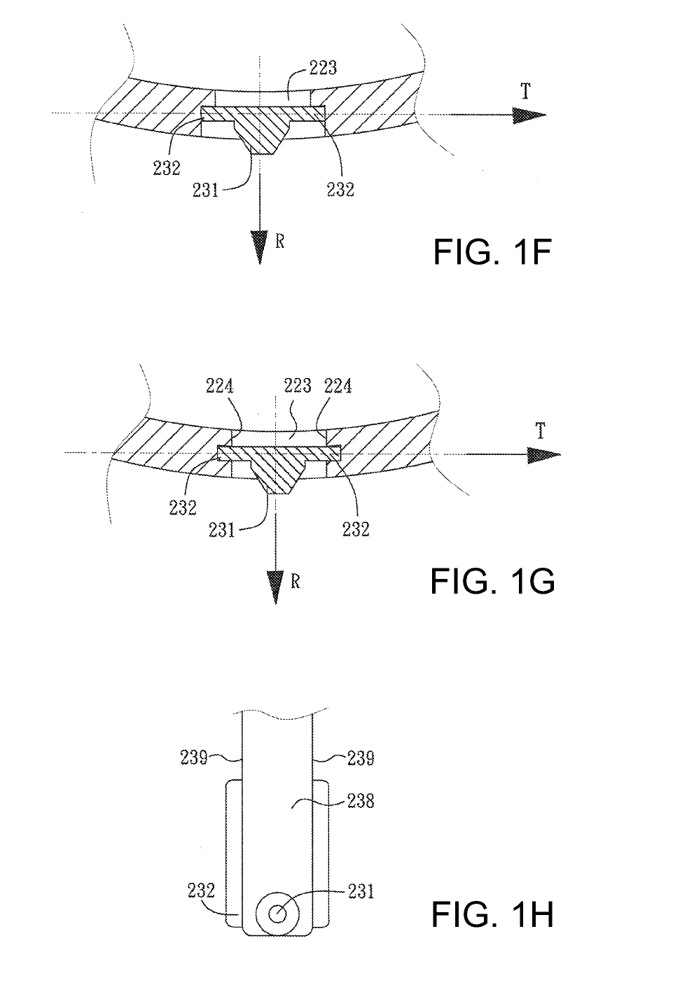

FIG. 1A shows a decomposition diagram of a lens structure 200 according to a preferred embodiment of the invention. The lens structure 200 includes a first lens barrel 210, a second lens barrel 220 and a third lens barrel 230.

As indicated in FIG. 1A, the second lens barrel 220 is disposed within the first lens barrel 210, and the third lens barrel 230 is disposed within the second lens barrel 220. The first lens barrel 210 has at least one guide groove 211. The second lens barrel 220 has at least one opening 221 having at least one concave groove 222 and a through hole 223. The through hole 223 is disposed on the second lens barrel 220 and passes through the outer and inner side walls of the second lens barrel 220. The concave groove 222 is formed on the edge of the through hole 223 on the outer side wall of the second lens barrel 220, and is directed towards the first lens barrel 210 so that the opening 221 is like a stair. The third lens barrel 230 includes at least one guide pin 231 and at least one subsidiary structure 232.

FIG. 1B shows the third lens barrel 230 of FIG. 1A disposed within the second lens barrel 220. Referring to both FIG. 1A and FIG. 1B. The guide pin 231 passes through the through hole 223 of the opening 221 and is disposed within the guide groove 211 of the first lens barrel 210. The guide pin 231 can move along the guide groove 211 so as to control the relative position between the third lens barrel 230 and the first lens barrel 210. When the guide pin 231 passes through the opening 221 and moves inside the guide groove 211, the subsidiary structure 232 concurrently slides in the concave groove 222 of the opening 221.

The third lens barrel 230 is sildably disposed within the second lens barrel 220 and rotationally connected within the first lens barrel 210 through the second lens barrel 220, wherein the first lens barrel 210 and the second lens 220 are rotated synchronously with respect to the first lens barrel 210. Further, because the guide pin 231 of the third lens barrel 230 passes through the opening 221 of the second lens barrel 220 and moves inside the guide groove 211 of the first lens barrel 210, the first lens barrel 210 and the second lens 220 are rotated concurrently with respect to the first lens barrel 210.

In the present embodiment of the invention, the third lens barrel 230 is realized by a lens frame, which h achieves zooming function by controlling the relative position between the third lens barrel 230 and the first lens barrel 210. However, the third lens barrel 230 is not limited to the above exemplification. The third lens barrel 230 can be realized by a lens barrel assembly with other function rather than a lens frame.

FIG. 1C shows a schematic diagram of the third lens barrel 230. In the present embodiment of the invention, the third lens barrel 230 has an optical axis 250 and a suspension arm structure 235. The optical axis 250 is directed in the Z direction. The suspension arm structure 235 includes a first extension portion 236, a second extension portion 237 and a third extension portion 238. The first extension portion 236 and the third extension portion 238 are respectively parallel to the optical axis 250 of the lens structure 200, and the second extension portion 237 is perpendicular to the optical axis 250, but the invention is not limited to such exemplification. Two ends of the second extension portion 237 are respectively connected to the first extension portion 236 and the third extension portion 238. The guide pin 231 and the subsidiary structure 232 are disposed on the third extension portion 238, and the subsidiary structure 232 and the third extension portion 238 and the guide pin 231 can be integrally formed in one piece. The subsidiary structure 232 can be fixed on the third extension portion 238 and the guide pin 231 in the manner of jointing or riveting.

Referring to both FIG. 1A and FIG. 1C. The radial direction R passes through the optical axis 250 and the guide pin 231, and is perpendicular to the optical axis 250. The guide pin 231 of the third lens barrel 230 is extended into the guide groove 211 of the first lens barrel 210 along the radial direction R.

FIG. 1D a cross-sectional top view showing the subsidiary structure 232 of the third lens barrel 230 moving along the concave groove 222 of the second lens barrel 220. Referring to both FIG. 1C and FIG. 1D, the tangent direction T of the second lens barrel 220 is perpendicular to the radial direction R and the optical axis 250. Meanwhile, the tangent direction T passes through the third extension portion 238. In greater details, the guide pin 231 and the subsidiary structure 232 are disposed on the third extension portion 238 of the suspension arm structure 235, and the third lens barrel 230 is disposed within the second lens barrel 220 so that the guide pin 231 passes through the opening 221 and makes the subsidiary structure 232 extended in the concave groove 222 of the opening 221 along the tangent direction T. The subsidiary structure 232 does not come off the second lens barrel 220 easily due to the limiting mechanism of the concave groove 222, so that the third extension portion 238 drives the guide pin 231 and the subsidiary structure 232 to slide in the guide groove 211 and the concave groove 222 of the first lens barrel 210 respectively. When the guide pin 231 receives a force directed towards the optical axis 250, the concave groove 222 provides an anti-directional force to push the subsidiary structure 232, so that the subsidiary structure 232 and the concave groove 222 bear the impact along the radial direction R to avoid the guide pin 231 coming off the guide groove 211 of the first lens barrel 210.

Referring to both FIG. 1E and FIG. 1F. According to the present embodiment of the invention, the subsidiary structure 232 of the third lens barrel 230 can be realized by a thin-film structure located on a lateral side 239 of the third extension portion 238. The thickness of the thin-film structure is the same with that of the third extension portion 238, and the thin-film structure is extended into the concave groove 222 along the tangent direction T. When receiving an impact, the concave groove 222 can support the thin-film structure to avoid the guide pin 231 being deviated towards the optical axis 250 or coming off. In addition, the thin-film structure can also bear the impact along the radial direction R to avoid the guide pin 231 coming off the guide groove 211 of the first lens barrel 210.

The shapes of the concave groove 222 of the second lens barrel 220 and the subsidiary structure 232 of the third lens barrel 230 are not subjected to any restrictions. As indicated in FIG. 1G, the concave groove 22, disposed at the central position of a side wall 224 of the through hole 223, not only stops the guide pin 231 moving towards the optical axis 250 but also avoids the guide pin 231 moving towards the guide groove 211, so that the third extension portion 238 will not come off the second lens barrel 220.

Referring to both FIG. 1H and FIG. 1I. According to the present embodiment of the invention, the subsidiary structure 232 of the third lens barrel 230 is realized by a thin-film structure located on a lateral side 239 of the third extension portion 23. The thickness of the thin-film structure can be smaller than that of the third extension portion 238.

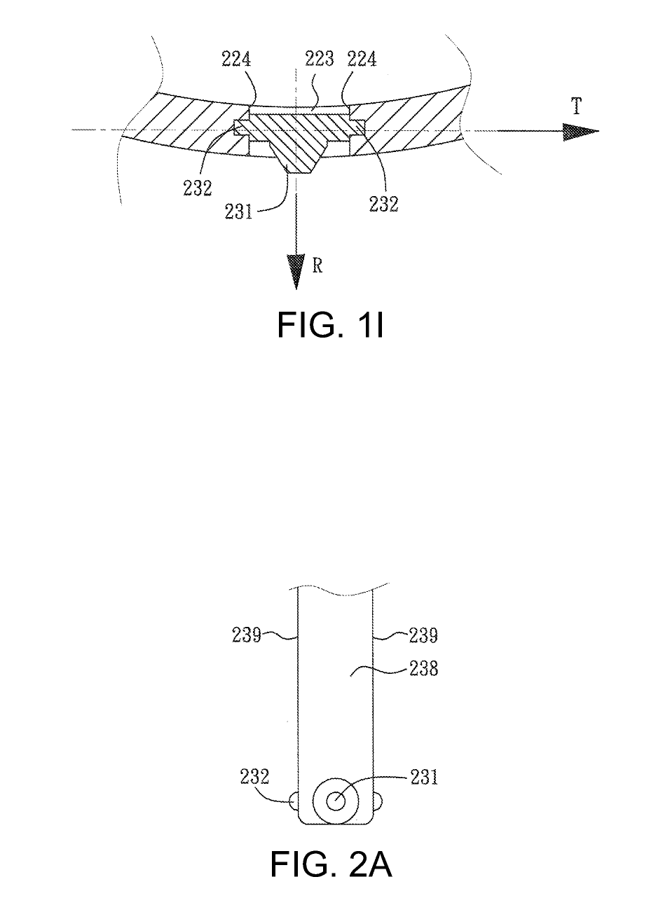

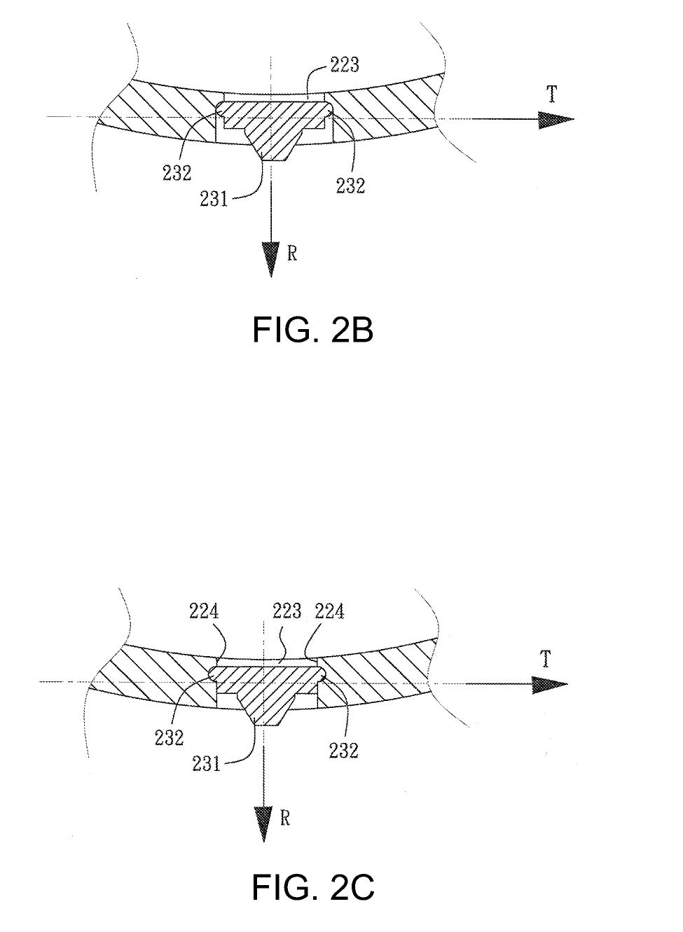

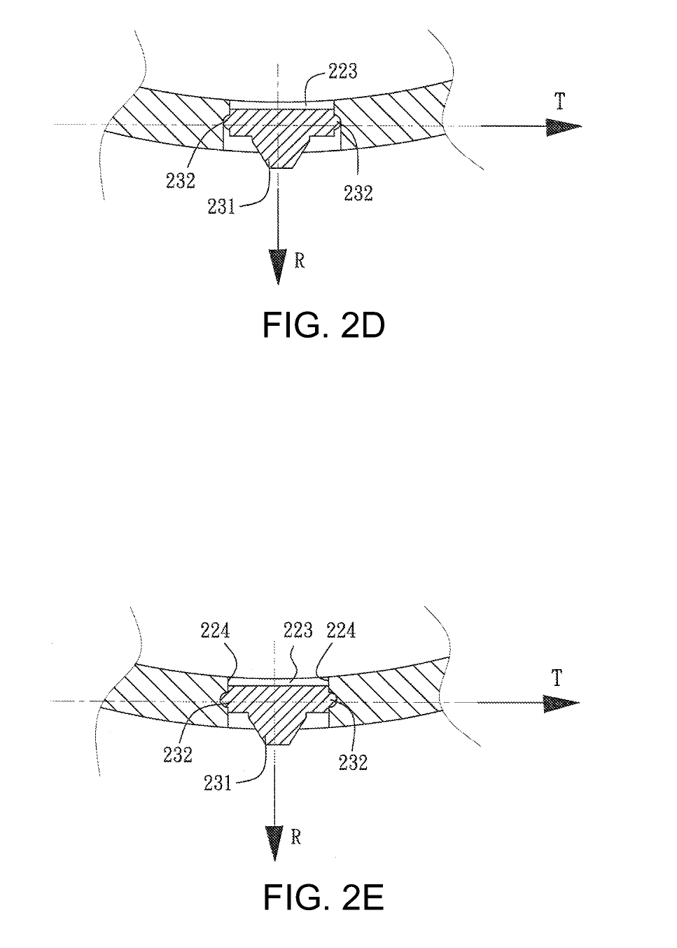

As indicated in FIG. 2A and FIG. 2B, the subsidiary structure 232 can be realized by a protrusion structure suitable to slide along the concave groove 222. The protrusion structure is located on a lateral side 239 of the third extension portion 238, and is extended on the concave groove 222 along the tangent direction T. As indicated in FIG. 2C, the concave groove 222 is located at the central position on the side wall 224 of the through hole 223. The protrusion structure moves in the concave groove 222. The concave groove 222 can precisely control the position of the guide pin 231. As indicated in FIG. 2D and FIG. 2E, the protrusion structure is located on the lateral side 239 of the third extension portion 238 and is symmetric to the guide pin 231.

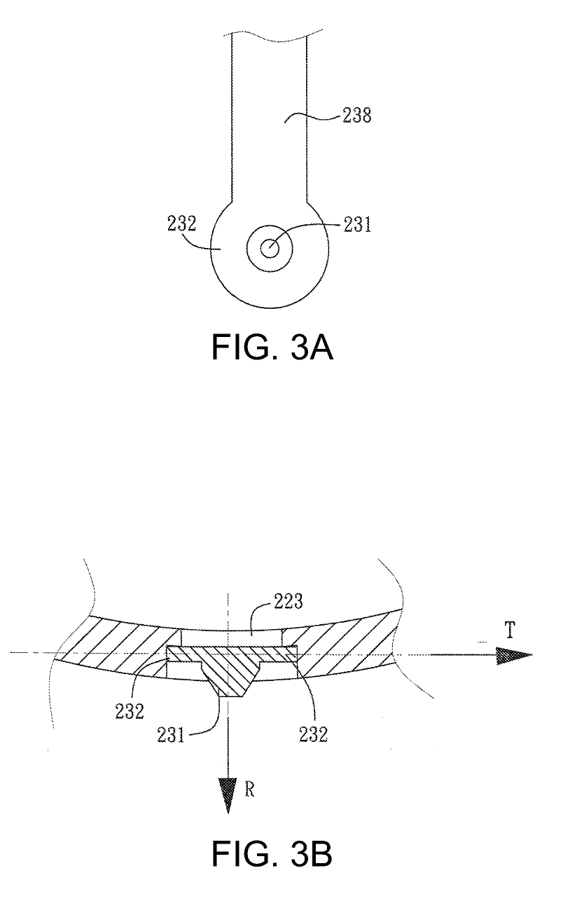

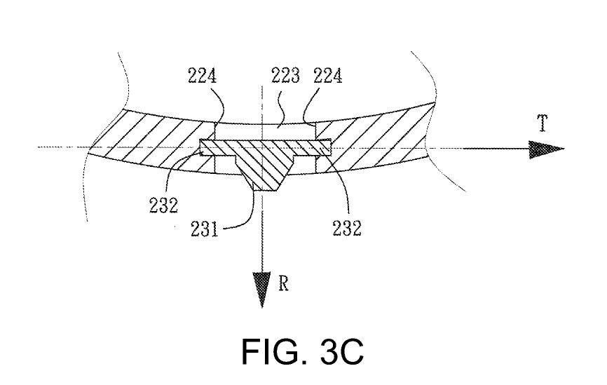

As indicated in FIG. 3A and FIG. 3B, the subsidiary structure 232 can also be realized by a ring structure suitable to slide along the concave groove 222. The ring structure surrounds the guide pin 231, and is extended to the concave groove 222. When receiving an impact, the above structure can provide sufficient strength to bear the impact along the radial direction R and avoid the guide pin 231 coming off the guide groove 211 of the first lens barrel 210. As indicated in FIG. 3C, the concave groove 222 is located at the central position on the side wall 224 of the through hole 223. The ring structure moves in the concave groove 222. The concave groove 222 can precisely control the position of the guide pin 231.

Through the above design, the subsidiary structure 232 of the third lens barrel 230 moves along the concave groove 222 of the second lens barrel 220 and limits the location of the guide pin 231 so that the guide pin 231 will not come off the guide groove 211 of the first lens barrel 210. When the lens structure 200 of the invention drops or collides with an object, the subsidiary structure 232 and the concave groove 222 can bear the impact and can maintain the location of the guide pin 231. Thus, the lens structure 200 of the invention will not cause the third lens barrel 230 to deviate from the optical axis 250 when the guide pin 231 comes off the guide groove 211, and the video recording device with the lens structure 200 is conformed to the consumers' requirements of the video recording device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens structure, comprising:
a first lens barrel having at least one guide groove;
a second lens barrel disposed within the first lens barrel, wherein the second lens barrel has at least one opening having a through hole and at least one concave groove; and
a third lens barrel disposed within the second lens barrel, wherein the third lens barrel has at least one guide pin and at least one subsidiary structure, the guide pin moves along the guide groove, and the subsidiary structure moves along the concave groove of the opening.

2. The lens structure according to claim 1, wherein, the concave groove is formed on an edge of the through hole.

3. The lens structure according to claim 1, wherein, the concave groove is formed on a side wall of the through hole.

4. The lens structure according to claim 1, wherein, the subsidiary structure is a thin-film structure, a protrusion structure, or a ring structure.

5. The lens structure according to claim 4, wherein, the thin-film structure is located on a lateral side of the guide pin.

6. The lens structure according to claim 4, wherein, the protrusion structure is located on a lateral side of the third extension portion.

7. The lens structure according to claim 4, wherein, the ring structure surrounds the guide pin and extends to the concave groove.

8. The lens structure according to claim 1, wherein, the guide pin is extended into the guide groove along a first direction, the subsidiary structure is extended into the concave groove of the opening along a second direction, and the second direction and the first direction are perpendicular to each other.

9. The lens structure according to claim 1, wherein, the third lens barrel has a suspension arm structure comprising a first extension portion, a second extension portion and a third extension portion, the two ends of the second extension portion are respectively connected to the first extension portion and the third extension portion, and the guide pin and the subsidiary structure are disposed on the third extension portion.

10. The lens structure according to claim 9, wherein, the subsidiary structure, the third extension portion and the guide pin are integrally formed in one piece.

11. The lens structure according to claim 9, wherein, the subsidiary structure, the third extension portion and the guide pin are mutually jointed and riveted.

12. The lens structure according to claim 9, wherein, the guide pin is extended into the guide groove along a first direction, the subsidiary structure is extended into the concave groove of the opening along a second direction, the third extension portion of the suspension arm structure is extended from the third lens barrel along a third direction, the first direction, the second direction and the third direction are perpendicular to each other, the third direction is parallel to an optical axis of the lens structure and the opening.

13. The lens structure according to claim 9, wherein, the thickness of thin-film structure is not larger than that of the third extension portion.

14. A digital camera comprising the lens structure claimed in claim 1.

15. A mobile information terminal comprising the lens structure claimed in claim 1.

16. An image inputting device comprising the lens structure claimed in claim 1.

17. A digital camera comprising the lens structure claimed in claim 9.

18. A mobile information terminal comprising the lens structure claimed in claim 9.

19. An image inputting device comprising the lens structure claimed in claim 9.

20. A lens structure, comprising:
a first lens barrel;
a second lens barrel, disposed within the first lens; and
a third lens barrel is sildably disposed within the second lens barrel and rotationally connected within the first lens barrel through the second lens barrel, wherein the first lens barrel and the second lens are rotated concurrently with respect to the first lens barrel.
